(19) United States
(12) Patent Application Publication
(10) Pub. No.: US 2026/0126535 A1
(43) Pub. Date: May 7, 2026

(54) BOAT SENSOR SYSTEM AND BOAT

(71) Applicant: YAMAHA HATSUDOKI KABUSHIKI KAISHA, Iwata-shi (JP)

(72) Inventors: Akihiro TAGATA, Shizuoka (JP); Kazumichi YOSHIDA, Shizuoka (JP)

(21) Appl. No.: 19/374,398

(22) Filed: Oct. 30, 2025

(30) Foreign Application Priority Data
Nov. 1, 2024 (JP) 2024-192847

(51) Int. Cl. G01S 7/497; B08B 3/02; B08B 5/02; B08B 13/00; B63B 59/00; G01S 7/481

(52) U.S. Cl. CPC G01S 7/497; B08B 3/02; B08B 5/02; B08B 13/00; B63B 59/00; G01S 7/4813; G01S 2007/4977

(57) ABSTRACT

A boat sensor system includes a sensor housing including a transmission window to transmit at least one of light or waves from outside the sensor housing, a sensor in the sensor housing and facing the transmission window, a liquid jet nozzle to jet liquid toward an outer surface of the transmission window, and a gas jet nozzle to jet gas toward the outer surface of the transmission window.

### CROSS REFERENCE TO RELATED APPLICATIONS

This application claims the benefit of priority to Japanese Patent Application No. 2024-192847 filed on Nov. 1, 2024. The entire contents of this application are hereby incorporated herein by reference.

### BACKGROUND OF THE INVENTION

### 1. Field of the Invention

The technologies disclosed herein relate to boat sensor systems and boats.

### 2. Description of the Related Art

Conventionally, a forward monitoring system has been known that uses a television camera to monitor the front of a boat (see e.g. JP 2007-022349 A, JP 2020-148811 A, and KR 10-2470100 B).

### SUMMARY OF THE INVENTION

The inventors of example embodiments of the present invention investigated a boat sensor system that monitors the surroundings of the boat using sensors such as LiDAR (light detection and ranging) rather than a television camera. This boat sensor system includes a sensor housing with a transmission window that transmits at least one of light and waves from the outside, and a sensor located inside the sensor housing and facing the transmission window. The sensor housing is exposed to the outside so foreign matter easily adheres to the transmission window. When foreign matter adheres to the transmission window, the sensing accuracy of the sensor decreases. In particular, when seawater adheres to the transmission window and dries, it becomes a white deposit. This deposit blocks the view of the sensor and is difficult to remove.

Example embodiments of the present invention disclose technologies that are able to solve the above-described problems, and can be implemented in the following example embodiments, for example.

A boat sensor system according to an example embodiment of the present invention includes a sensor housing including a transmission window to transmit at least one of light or waves from outside the sensor housing, a sensor in the sensor housing and facing the transmission window, a liquid jet nozzle to jet liquid toward an outer surface of the transmission window, and a gas jet nozzle to jet gas toward the outer surface of the transmission window.

The technologies disclosed herein can be implemented in various applications and example embodiments including, e.g., boat sensor systems, sensors, boats, cleaning systems including liquid jet nozzles, gas jet nozzles, and controllers, a computer program for determining the presence or absence of adhered matter on the transmission window of the sensor, and a non-transitory computer-readable recording medium storing the computer program.

The example embodiments can, e.g., wash away the adhered matter on the transmission window by jetting liquid onto the outer surface of the transmission window using a liquid jet nozzle and blow away the water droplets remaining on the outer surface by jetting gas using a gas jet nozzle.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view schematically illustrating a configuration of a boat.

FIG. 2 is an explanatory view illustrating a configuration of a boat sensor system.

FIG. 3 is a flowchart showing the flow of a cleaning process.

### DETAILED DESCRIPTION OF THE EXAMPLE EMBODIMENTS

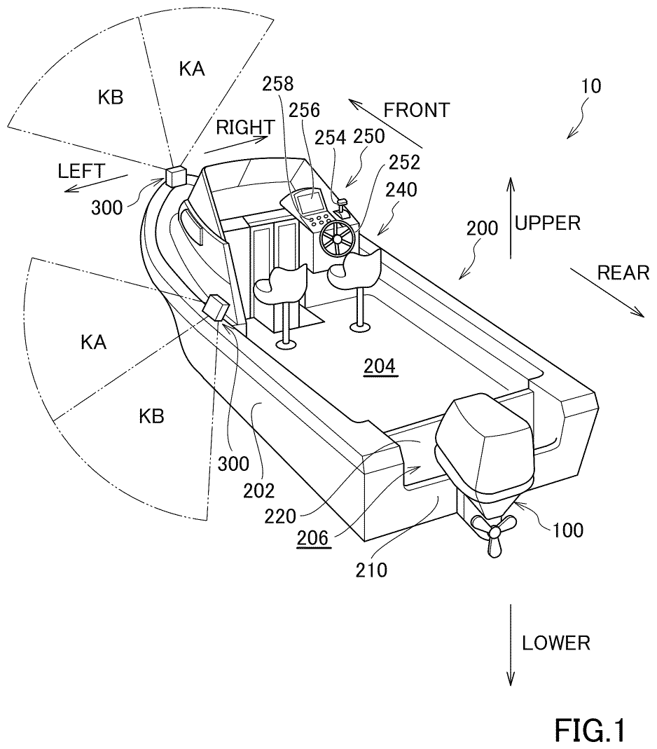

FIG. 1 is a perspective view schematically illustrating a configuration of a boat 10. FIG. 1 shows arrows representing each direction with respect to the position of the boat 10. More specifically, each figure shows arrows representing the front direction (FRONT), rear direction (REAR), left direction (LEFT), right direction (RIGHT), upper direction (UPPER), and lower direction (LOWER), respectively. The front-rear direction, left-right direction, and upper-lower (vertical) direction are orthogonal to each other. It should be noted that, in this specification, axes, members, and the like, extending in the front-rear direction need not necessarily be parallel to the front-rear direction. Axes and members extending in the front-rear direction include axes and members that are inclined in the range of +45° to the front-rear direction. Similarly, axes and members extending in the upper-lower direction include axes and members inclined within a range of +45° to the upper-lower direction, and axes and members extending in the left-right direction include axes and members inclined within a range of +45° to the left-right direction.

The boat 10 includes a boat body 200 and an outboard motor 100. In this example embodiment, the boat 10 includes only one outboard motor 100, but the boat 10 may have multiple outboard motors 100.

The boat body 200 is the portion of the boat 10 for occupants to ride. The boat body 200 includes a boat main body 202, a pilot seat 240, and a steering device 250. The boat main body 202 includes a living space 204. The pilot seat 240 is located in the living space 204. The steering device 250 is located near the pilot seat 240. The steering device 250 steers the boat. The steering device 250 includes, e.g., a steering wheel 252, a shift/throttle lever 254, a monitor 256, and an input device 258. The boat body 200 also includes a partition wall 220 and a transom 210. The partition wall 220 partitions the space at the rear end of the living space 204. The transom 210 is located at the rear end of the boat body 200. In the front-rear direction, there is a space 206 between the transom 210 and the partition wall 220.

The outboard motor 100 generates thrust to propel the boat 10. The outboard motor 100 is attached to the transom 210 at the rear portion of the boat body 200.

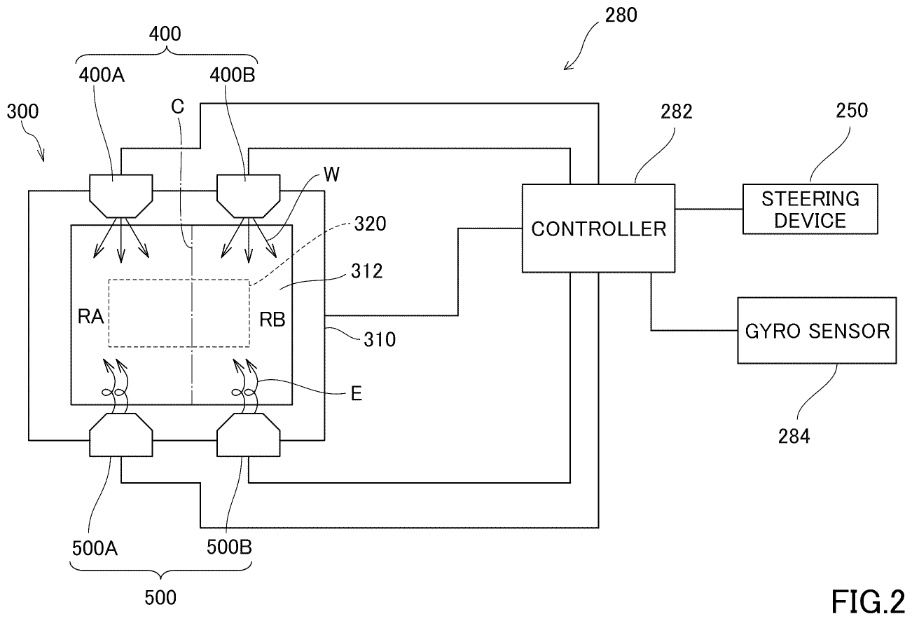

As shown in FIG. 2, the boat system 280 includes one or more sensors 300, one or more liquid jet nozzles 400, one or more gas jet nozzles 500, a controller 282, and a gyro sensor 284.

The sensors 300 are attached to the boat body 200 (boat main body 202) and sense the surroundings of the boat body 200. In the example shown in FIG. 1, three sensors 300 are attached to the boat main body 202. The sensor 300 attached to the tip of the boat main body 202 senses in the forward direction of the boat body 200. The sensor 300 attached to the right side of the boat main body 202 (not shown in FIG. 1) senses in the right direction of the boat main body 202. The sensor 300 attached to the left side of the boat body 200 senses in the left direction of the boat body 200.

The sensor 300 may be, e.g., a FLASH-type LiDAR that can measure the presence or absence of objects, their shape, and the distance to the objects in the vicinity of the boat body 200. The sensor 300 may also include a scanning-type LiDAR. The sensor 300 includes a sensor housing 310 and a sensor 320.

The sensor housing 310 includes a transmission window 312. The surface of the transmission window 312 is exposed to the outside of the sensor housing 310. The transmission window 312 is made of a light-transmitting member that transmits light (laser light). The color of the transmission window 312 is not limited to transparent and can be any color that allows light (laser light) to pass therethrough (e.g., black). The transmission window 312 is directed in the sensing direction of the sensor 300.

The sensor 320 is housed inside the sensor housing 310 and faces the transmission window 312. The sensor 320 includes a plurality of light-emitting elements (such as laser diodes) that emit laser light, and a plurality of light-receiving elements (such as single photon avalanche diodes (SPADs)) that receive reflected light that has been reflected by an object and returned. The sensor may also be another image sensor (such as a CMOS sensor or a charge-coupled device).

The liquid jet nozzle 400 jets liquid W (e.g., cleaning water) toward the outer surface of the transmission window 312. The liquid jet nozzle 400 is disposed at the upper side of the transmission window 312 and jets liquid W in the downward direction. Two liquid jet nozzles 400A, 400B are provided for one sensor 300. The jet outlets of the two liquid jet nozzles 400A, 400B are each directed at different regions on the outer surface of the transmission window 312. Specifically, the outer surface of the transmission window 312 includes a first region RA and a second region RB equally divided in the left-right direction. The jet outlet of the first liquid jet nozzle 400A is directed toward the first region RA. The jet outlet of the second liquid jet nozzle 400B is directed toward the second region RB. The two liquid jet nozzles 400A, 400B can selectively jet liquid W into multiple regions on the outer surface of the transmission window 312.

The gas jet nozzle 500 jets gas E (such as air) toward the outer surface of the transmission window 312. The gas jet nozzle 500 is disposed at the lower side of the transmission window 312 and jets gas E in an upward direction. Two gas jet nozzles 500A, 500B are provided for one sensor 300. The jet outlets of the two gas jet nozzles 500A, 500B are respectively directed to different regions on the outer surface of the transmission window 312. The jet outlet of the first gas jet nozzle 500A is directed toward the first region RA. The jet outlet of the second gas jet nozzle 500B is directed toward the second region RB. The two gas jet nozzles 500A, 500B can selectively jet gas E toward multiple regions on the outer surface of the transmission window 312.

The controller 282 may include, e.g., a CPU, a multi-core CPU, and/or a programmable device (e.g., Field programmable gate array (FPGA), programmable logic device (PLD)). The controller 282 controls the operation of the boat 10. In other words, the controller 282 controls the magnitude and direction of the thrust of the outboard motor 100 according to the operation received by the steering device 250.

The controller 282 includes a storage device. The storage device may include, e.g., a ROM, a RAM, a hard disk drive (HDD), and/or a solid-state drive (SDD). The storage device stores various programs and data and is used as a work area or data storage area when executing various processes. For example, a computer program for executing the cleaning process described below is stored in the storage device. This computer program is provided, e.g., in a computer-readable recording medium such as a CD-ROM, DVD-ROM, or USB memory (not shown), or it can be obtained from an external device (e.g., a server in the cloud) via a communication interface (not shown) and stored in a storage device in a manner that can be executed on the boat system 280.

The gyro sensor 284 outputs a detection signal corresponding to the attitude of the boat body 200 (tilt angle of the boat body 200 in the horizontal direction). The gyro sensor 284 is an example of an attitude sensor. The controller 282 is communicatively connected to the sensor 300, the liquid jet nozzle 400, the gas jet nozzle 500, the steering device 250, and the gyro sensor 284.

The controller 282 acquires the degree of change in the attitude (hereinafter, referred to as “degree of attitude change”) of the boat body 200 by receiving the detection signals from the gyro sensor 284 at predetermined time intervals.

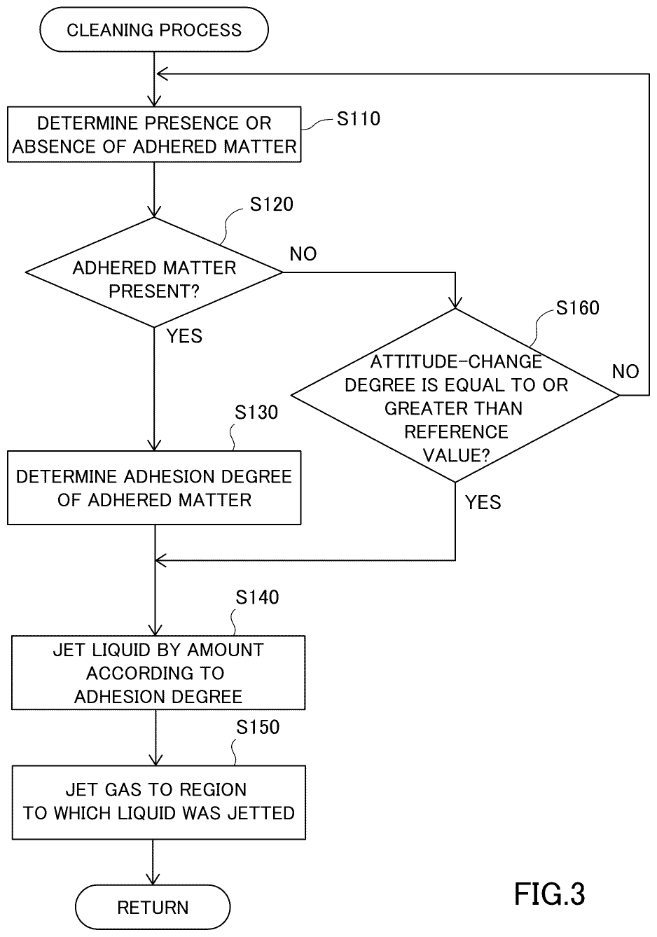

FIG. 3 is a flowchart showing the flow of a cleaning process. The cleaning process cleans the transmission window 312 of the sensor 300. For example, the liquid jet nozzle 400 jets liquid W onto the outer surface of the transmission window 312 to wash away any adhered matter (foreign matter) that has adhered to the transmission window 312, and the gas jet nozzle 500 jets gas E to blow away any water droplets that remain on the outer surface. The adhered matter may include, e.g., dust, dirt such as salt from dried seawater, and seawater, among others. If there is any adhered matter on the outer surface of the transmission window 312, the sensing accuracy of the sensor 300 may be reduced. For example, when the power of the steering device 250 is turned on, the controller 282 repeatedly executes the cleaning process, not only when the boat 10 is sailing, but also when the outboard motor 100 is stopped (e.g., when it is at anchor).

As shown in FIG. 3, the controller 282 determines whether there is any adhered matter (foreign matter) on the outer surface of the transmission window 312 of the sensor 300 (S110). The controller 282 determines that there is adhered matter on the transmission window 312 when light reception results (changes in received light quantity and/or reflectance) acquired by the sensor 300 satisfy adhesion conditions. The adhesion conditions include, e.g., that the amount of position change of the sensor 300 is greater than or equal to the reference value, and that there is an unchanged portion (a portion where the light intensity or reflectance does not change) that does not move from a certain region among the multiple light reception results (changes in light intensity or reflectance) acquired at different times by the sensor 300. If there is an unchanged portion in the light reception results that change in accordance with the position change of the sensor 300, there is a high possibility that the unchanged portion corresponds to an image region of adhered matter on the transmission window 312. Therefore, the controller 282 can determine the presence or absence of adhered matter on the transmission window 312 based on the presence or absence of unchanged portions in the light reception results acquired by the sensor 300 when the amount of position change of the sensor 300 is equal to or more than the reference value.

The amount of position change of the sensor 300 is the amount of change in the position of the sensor 300 per unit time. The direction of the position change is not limited to the upper-lower direction and may include other directions (e.g., a horizontal direction). The controller 282 measures the amount of position change of the sensor 300 per unit time based on the detection signal from the gyro sensor 284. The position change of the sensor 300 occurs not only during the sailing (moving) of the boat 10, but also when the boat 10 moves by waves while at anchor, for example. The controller 282 accurately determines whether there is any adhered matter on the transmission window 312 by combining the position change (swaying) of the sensor 300 (the boat 10) itself and the presence or absence of an unchanged portion in the light reception results, regardless of whether the boat 10 is sailing or at anchor.

Upon determining that there is adhered matter on the outer surface of the transmission window 312 of the sensor 300 (S120: YES), the controller 282 causes the liquid jet nozzle 400 to jet liquid W and then causes the gas jet nozzle 500 to jet gas E.

Specifically, the controller 282 determines the degree of adhesion of the adhered matter on the transmission window 312 based on the sensing results from the sensor 300 (S130). The controller 282 analyzes the light reception results acquired by the sensor 300 to determine the degree of adhesion based on at least one of the color density of the unchanged portion, the size of the unchanged portion, or the number of the unchanged portions. The controller 282 determines that the degree of adhesion is higher the darker the color of the unchanged portion, that the degree of adhesion is higher the larger the size of the unchanged portion, or that the degree of adhesion is higher the greater the number of unchanged portions.

Next, the controller 282 activates the liquid jet nozzle 400. The liquid jet nozzle 400 jets liquid W toward the outer surface of the transmission window 312. The controller 282 increases the amount of liquid W jetted by the liquid jet nozzle 400 (S140) as the determined degree of adhesion increases. Increasing the amount of liquid W jetted may include one or more of the following three methods:
(1) increasing the jet time during which the liquid jet nozzle 400 jets liquid W;
(2) increasing the jet frequency with which the liquid jet nozzle 400 jets liquid W within a predetermined time; and
(3) increasing the amount of liquid W per unit time (jetting pressure) jetted by the liquid jet nozzle 400.

The greater the degree of adhesion of the adhered matter on the outer surface of the transmission window 312, the greater the amount of liquid W jetted, the more effectively the adhered matter is removed.

Among the plurality of the liquid jet nozzles 400, the controller 282 causes the liquid jet nozzle 400 corresponding to the region where the adhered matter is present to jet liquid W, and does not cause the liquid jet nozzle 400 corresponding to the region where there is no adhered matter to jet liquid W. For example, if there is adhered matter adhered on the first region RA and there is no adhered matter on the second region RB of the transmission window 312, the first liquid jet nozzle 400A will jet liquid W toward the first region RA, and the second liquid jet nozzle 400B will not jet liquid W toward the second region RB. Water droplets may be adhered to the region of the transmission window 312 where liquid W is jetted, so that there is a risk that the sensing accuracy of the sensor 300 will be reduced by the presence of the water droplets until the water droplets are removed. Therefore, not jetting liquid in regions where there are no adhered matter will prevent the reduction in sensing accuracy caused by the water droplets.

The controller 282 may stop the jetting from the liquid jet nozzle 400 based on the sensing results from the sensor 300 when it has been determined that there is no adhered matter on the transmission window 312 (the degree of adhesion is below a reference level).

Next, the controller 282 stops the liquid jet nozzle 400 from jetting and activates the gas jet nozzle 500. The gas jet nozzle 500 jets gas E toward the outer surface of the transmission window 312.

Among the plurality of the gas jet nozzles 500, the controller 282 causes the gas jet nozzle 500 corresponding to the region where the liquid jet nozzle 400 has jetted liquid W to jet gas E and does not cause the gas jet nozzles 500 corresponding to the region where the liquid jet nozzle 400 has not jetted liquid W to jet gas E. For example, in the transmission window 312, if the first liquid jet nozzle 400A has jetted liquid W toward the first region RA and the second liquid jet nozzle 400B has not jetted liquid W toward the second region RB, the gas jet nozzle 500A jets gas E toward the first region RA, and the second gas jet nozzle 500B does not jet gas E toward the second region RB. The plurality of gas jet nozzles 500 are connected to a common gas supply source. Therefore, the smaller the number of gas jet nozzles 500 that are jetting gas E at the same time, the greater the jetting pressure per gas jet nozzle 500. Therefore, not jetting gas toward the region where the liquid jet nozzle 400 has not jetted liquid W will increase the jetting pressure of gas E jetted toward the region where the liquid jet nozzle 400 jetted liquid W (the region where adhered matter existed), thus removing adhered matter and water droplets more quickly.

Upon determining that there is no adhered matter on the outer surface of the transmission window 312 of the sensor 300 (S120: NO), the controller 282 determines whether or not the degree of attitude change of the sensor 300 (the sensor housing 310) is equal to or greater than a reference value (S160). The controller 282 determines whether the amount of attitude change of the boat body 200 (the sensor housing 310) (the amount of change in the tilt angle of the boat body 200) is greater than a reference value based on the detection signal from the gyro sensor 284. The greater the waves around the boat body 200, the greater the change in the attitude of the boat body 200, and the higher the likelihood that water from the waves (seawater droplets) will hit the sensor 300 and that the seawater that adheres to the transmission window 312 will become adhered matter.

If the controller 282 determines that the degree of attitude change of the sensor 300 is less than the reference value (S160: NO), the process returns to S110. On the other hand, if the controller 282 determines that the degree of attitude change of the sensor 300 is greater than the reference value (S160: YES), the controller 282 executes the processes in S140 and S150 regardless of whether there is any adhered matter on the transmission window 312.

The controller 282 increases at least one of the amount of liquid W jetted per unit time by the liquid jet nozzle 400 or the amount of gas E jetted per unit time by the gas jet nozzle 500 as the determined degree of attitude change increases. The method of increasing the amount of liquid W jetted is as described above. The method of increasing the amount of gas E jetted includes one or more of the following three methods:
(1) increasing the jet time during which the gas jet nozzle 500 jets gas E;
(2) increasing the jetting frequency with which the gas jet nozzle 500 jets gas E within a predetermined time; and
(3) increasing the amount of gas E per unit time (jetting pressure) jetted by the gas jet nozzle 500.

In addition, if there is no adhered matter on the transmission window 312 and the degree of attitude change of the sensor 300 is greater than the reference value (S120: NO and S160: YES), the controller 282 may cause the gas jet nozzle 500 to jet gas E (S150) without causing the liquid jet nozzle 400 to jet liquid W (S140). If the droplets of seawater that have adhered to the transmission window 312 have not dried, the droplets of seawater can be blown away by gas E jetted from the gas jet nozzle 500. This can reduce the consumption of liquid W (cleaning water) jetted from the liquid jet nozzle 400.

The technologies disclosed herein are not limited to the above-described example embodiments and may be modified in various ways without departing from the gist of the present invention, including the following modifications.

The configuration of the boat 10 and sensor 300 in the above example embodiments is just one example, and can be modified in various ways. For example, in the above example embodiments, the boat is exemplified by the boat 10 including an outboard motor, but the boat may include an electric propulsion device, a water jet propulsion boat, an inboard motor, or an inboard/outboard motor. The drive source for the propulsion device or the like is not limited to an engine, and may also be an electric motor, among others. In the above example embodiments, the sensor 300 may be attached to the rear end of the boat body 200, a navigation light, or the like. In the above example embodiments, a cleaning system, which includes the liquid jet nozzle 400, the gas jet nozzle 500, and the controller 282, may be provided independently of the sensor 300. In this case, the sensor 300, the liquid jet nozzle 400, and the gas jet nozzle 500 may be separate units. The controller 282 may be integrated into the sensor 300, or it may be provided outside the sensor 300 (e.g., in the steering device 250).

In the above example embodiments, the sensor 320 may be an imaging element, a millimeter wave laser, an ultrasonic element, and a proximity sensor, among others. The transmission window 312 may be made of a material that transmits at least one of electromagnetic waves or mechanical waves, e.g., light (visible light, infrared light, and the like) or waves (radio waves, sound waves, millimeter waves, and the like) from the outside.

In the above example embodiments, the liquid jet nozzle 400 may not be disposed at the upper side of the transmission window 312, e.g., it may be disposed at the lower side of the transmission window 312 and jet liquid W in the upward direction, or it may be arranged on the right or left side of the transmission window 312 and jet liquid W in the leftward or rightward direction. In the above example embodiments, one or three or more liquid jet nozzles 400 may be provided for one sensor 300.

In the above example embodiments, the gas jet nozzle 500 may not be disposed at the lower side of the transmission window 312, e.g., it may be disposed at the upper side of the transmission window 312 and jet gas E in the downward direction, or it may be disposed at the right side or left side of the transmission window 312 and jet gas E in the leftward or rightward direction. In the above example embodiments, one or three or more gas jet nozzles 500 may be provided for one sensor 300.

In the above example embodiments, any other known methods can be used as the method for determining whether there is any adhered matter on the transmission window 312 of the sensor 300. For example, the degree of adhesion can be determined by using an imaging element as the sensor to analyze the image captured by the imaging element based on at least one of the color density of the unchanged portion, the size of the unchanged portion, or the number of unchanged portions. In addition, for example, multiple light reception results received by using a sensor at different times may be compared with regard to each of the corresponding pixels to obtain a single maximum difference reception result by using the pixel with the largest difference in density between pixels, and pixels with a density below a threshold value in the maximum difference reception result may be determined to be dirty pixels (adhered matter).

In S110 of FIG. 3, the controller 282 may measure the amount of position change of the sensor 300 per unit time based on the position signal from a position sensor. The position sensor may include a receiver for a global navigation satellite system (GNSS), such as a global positioning system (GPS), for example. Even if the controller 282 determines that there is adhered matter (S120: YES), if the degree of adhesion is below the reference level, it is not necessary to execute at least one of the processes in S140 and S150. If the controller 282 determines that there is adhered matter (S120: YES), the controller 282 may cause the liquid jet nozzle 400 to jet liquid W (S140) and cause the gas jet nozzle 500 to jet gas E (S150) at the same time.

In S140 of FIG. 3, the liquid jet nozzle 400 may jet liquid W at a constant jet volume regardless of the degree of adhesion of the adhered matter. For the multiple liquid jet nozzles 400, the controller 282 may make the amount of liquid W jetted from the liquid jet nozzle 400 corresponding to the region with adhered matter relatively larger than the amount of liquid W jetted from the liquid jet nozzle 400 corresponding to the region without adhered matter. The controller 282 may make liquid W jetted from the multiple liquid jet nozzles 400 uniform regardless of the position of the adhered matter on the transmission window 312.

In S150 of FIG. 3, for the multiple gas jet nozzles 500, the controller 282 may make the amount of gas E jetted from the gas jet nozzle 500 corresponding to the region to which the liquid jet nozzle 400 has jetted liquid W relatively larger than the amount of gas E jetted from the gas jet nozzle 500 corresponding to the region to which the liquid jet nozzle 400 has not jetted liquid W. The controller 282 may cause gas E to be uniformly jetted from the multiple gas jet nozzles 500 regardless of whether the liquid jet nozzle 400 has jetted liquid W or not.

In the above example embodiments, the attitude sensor and the position sensor may correspond to the gyro sensor 284 and the like arranged in the boat body 200, but the configuration is not limited to this, for example, they may be the attitude sensor or position sensor incorporated in the sensor 300.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A boat sensor system comprising:
a sensor housing including a transmission window to transmit at least one of light or waves from outside the sensor housing;
a sensor in the sensor housing and facing the transmission window;
a liquid jet nozzle to jet liquid toward the outer surface of the transmission window; and
a gas jet nozzle to jet gas toward the outer surface of the transmission window.

2. The boat sensor system according to claim 1, wherein
the liquid jet nozzle includes a plurality of liquid jet nozzles; and
jet outlets of the plurality of liquid jet nozzles are each directed at a different region on the outer surface of the transmission window.

3. The boat sensor system according to claim 1, wherein
the gas jet nozzle includes a plurality of gas jet nozzles; and
jet outlets of the plurality of gas jet nozzles are each directed at a different region on the outer surface of the transmission window.

4. The boat sensor system according to claim 1, further comprising:
a controller configured or programmed to:
determine a degree of adhesion of adhered matter on the outer surface of the transmission window based on sensing results from the sensor; and
increase an amount of liquid jetted by the liquid jet nozzle as the degree of adhesion increases.

5. The boat sensor system according to claim 1, further comprising:
a controller configured or programmed to:
determine a degree of attitude change of the sensor housing; and
increase at least one of an amount of liquid jetted by the liquid jet nozzle and an amount of gas jetted by the gas jet nozzle as the degree of attitude change increases.

6. The boat sensor system according to claim 1, further comprising:
a controller configured or programmed to:
determine an amount of position change of the sensor housing; and
determine that there is adhered matter on the outer surface of the transmission window based on the amount of position change being equal to or more than a reference value and there is an unchanged portion that does not move or change from a certain point in light reception results acquired by the sensor.

7. The boat sensor system according to claim 1, further comprising:
a controller configured or programmed to cause the liquid jet nozzle to jet liquid and then cause the gas jet nozzle to jet gas when adhered matter is detected on the outer surface of the transmission window.

8. A boat comprising:
a boat body; and
the boat sensor system according to claim 1 attached to the boat body.

9. The boat according to claim 8, further comprising
a controller configured or programmed to:
determine a degree of adhesion of adhered matter on the outer surface of the transmission window based on sensing results from the sensor; and
increase an amount of liquid jetted by the liquid jet nozzle as the degree of adhesion increases.

10. The boat according to claim 8, further comprising:
a controller; and
an attitude sensor to detect an attitude of the boat body; wherein
the controller is configured or programed to:
determine a degree of attitude change of the sensor housing based on detection results from the attitude sensor; and
increase at least one of an amount of liquid jetted by the liquid jet nozzle or an amount of gas jetted by the gas jet nozzle as the degree of attitude change increases.

11. The boat according to claim 8, further comprising
a controller; and
an attitude sensor to detect an attitude of the boat body; wherein
the controller is configured or programmed to:
determine a degree of attitude change of the sensor housing based on detection results from the attitude sensor; and
determine that there is adhered matter on the outer surface of the transmission window when the degree of attitude change is equal to or more than a reference level and there is an unchanged portion that does not move or change from a certain point in light reception results acquired by the sensor.

12. The boat according to claim 8, further comprising a controller configured or programmed to cause the liquid jet nozzle to jet liquid and then cause the gas jet nozzle to jet gas when adhered matter is detected on the outer surface of the transmission window.
